(19) United States
(12) Patent Application Publication
(10) Pub. No.: US 2004/0134119 A1
(43) Pub. Date: Jul. 15, 2004

(54) Releasable fishing line sinker assemblage and method of using same

(76) Inventors: Larry V. Glavinich, Banning, CA (US); Rodney Long, Banning, CA (US)

Correspondence Address: James E. Brunton, Esquire, Post Office Box 29000, Glendale, CA, 91209-9000, US

(21) Appl. No.: 10/746,392

(22) Filed: Dec. 24, 2003

Related U.S. Application Data
(60) Provisional application No. 60/437,086, filed on Dec. 27, 2002.

(51) Int. Cl. A01K 91/00; A01K 93/00; A01K 95/00

(52) U.S. Cl. 43/44.87

(57) ABSTRACT

A fishing line sinker assemblage and the method of using same including a sinker having a streamlined, weighted body that is provided with a longitudinally extending, central bore. A novel fishing line connector and release means which comprises a yieldably deformable relatively light gauge stainless steel wire securement member is telescopically receivable within the central base of the weight body. The securement member includes a uniquely formed, spiral shaped connector loop that enables the connector and release means to be readily interconnected with a fishing line without cutting the line or removing the hook or swivel. Once the fishing line has been connected to the release means, the legs of the release means are fed through the central bore of the weighted body and one or more of the legs is bent outwardly and then cut. Should the weight become snagged, the weight can be expeditiously released from the release means by exerting an upward pressure on the fishing line. Once the weight is released, the fish can then be played in a conventional manner and the entire rigging, less the sinker can be recovered.

### BACKGROUND OF THE INVENTION

1. Field of the Invention

The present invention relates generally to sinkers for use in fishing. More particularly, the invention concerns an improved, readily releasable sinker that can be quickly and easily attached to a fishing line and can easily be freed from the fishing line if the sinker hangs up on rocks or becomes otherwise entangled.

2. Description of the Prior Art

A large number of fishing sinker designs have been suggested in the past. One very common and widely used sinker is that described in U.S. Pat. No. 2,701,427 issued to Veranda. The Veranda invention concerns a round shot type sinker having a slot that extends through the sinker. The sinker can be easily attached to a fishing line above the hook by pinching the sinker around the line. Although this type of a sinker enjoys widespread popularity, it has certain drawbacks. For example, the line usually passes through the sinker in an off-center position and the rounded stubby shape of the sinker allows the sinker to catch on weeds as it is pulled through the water.

Another highly successful type of prior art sinker in which the line passes through the center of the sinker is exemplified by a prior art sinker sold by the Mojo Lure Company of Banning, Calif., which is the assignee of the present invention. This sinker has an elongated body that is provided with a centrally disposed line-receiving passageway. In using this device the fishing line is first inserted through the line-receiving passageway. Next, a wire threader is threaded through the central passageway of the sinker and one or more rubber strips are attached to the threaded. Using the threader, the rubber strips are pulled through the sinker body in a manner to slidably affix the sinker to the line.

Still another type of sinker is shown in U.S. Pat. No. 1,564,147 issued to Stickley. This patent discloses a sinker comprising a conically shaped body of heavy material having parallel openings and a releasing device of bent, relatively stiff wire, which is connected to the fishing line by a knot in an ordinary manner. The legs of the bent wire pass through the parallel openings and are bent outwardly to increase their holding effect.

The present invention comprises an improvement to the art of fishing line sinkers by providing a sinker having a body of a streamlined shape that is provided with a longitudinally extending central bore that is adapted to receive a novel bent, light spring wire line connector and release mechanism. The novel line connector has a generally spiral shaped line connector portion which comprises first and second, adjacently disposed coils that define a generally circular shaped line receiving opening. During use, the line can be connected to the spring wire line connector in a matter of seconds without the necessity of cutting the line or disassembling the fishing rig. This is uniquely accomplished by feeding the line around the spiral loop in a clockwise direction, much like installing keys on a key ring, to cause the line to extend through the line-receiving opening. The sinker is then attached to the connector wire by sliding the wire legs of the connector wire through the central bore of the sinker and then bending one or both of the legs outwardly.

### SUMMARY OF THE INVENTION

By way of brief summary, the present invention comprises a fishing line sinker assemblage including a streamlined, weighted body that is provided with a longitudinally extending, central bore and a fishing line connector and release means that is telescopically received within the central bore of the weighted body. In one form of the invention, the fishing line connector and release means comprises a yieldably deformable relatively light gauge stainless steel wire securement member that includes a uniquely formed, spiral shaped connector loop that enables the connector and release means to be readily interconnected with a fishing line without cutting the line or removing the hook or swivel. Once the fishing line has been connected to the release means, the legs of the release means are fed through the central bore of the weighted body and one or more of the legs is bent outwardly and then cut.

With this construction described in the preceding paragraph, should the weight become snagged, the weight can be expeditiously released from the release means by exerting an upward pressure on the fishing line. Once the weight is released, the fish can then be played in a conventional manner and the entire rigging, less the sinker can be recovered.

It is an object of the present invention to provide a novel fishing line sinker assemblage that can be quickly and easily interconnected with the fishing line without cutting the line or disassembling the rig.

Another object of the invention of is to provide a fishing line sinker assemblage of the aforementioned character in which, should the sinker become snagged, the sinker can be released from the line by the exertion of an upward pressure on the line to enable recovery of the entire fishing rig less the sinker.

Another object of the invention is to provide a fishing line sinker assemblage, which includes a sinker of a streamlined shape that mitigates against snagging on weeds, grass and like fishing cover.

Another object of the invention is to provide a novel fishing line sinker assemblage that is easy to use, is of simple construction and is inexpensive to manufacture.

Another object of the invention is to allow the hand cylindrical sinker the ability to hang vertical on the fishing line which makes this upright system much less apt to snag. The stainless wire loop also allows the sinker to twist and move in any direction while coming through bottom debris. It also eliminates nearly all resistance while sliding on the fishing line, eliminating line damage a with most sinkers with a thin bare.

### BRIEF DESCRIPTION OF THE DRAWINGS

FIG. 1 is an exploded view of one form of the assemblage of the invention showing the sinker portion thereof in cross section.

FIG. 2 is a generally diagrammatic, perspective view illustrating the various steps involved in interconnecting the sinker with the fishing rig.

FIG. 3 is a generally diagrammatic, perspective view illustrating the sinker interconnected with the fishing rig.

FIG. 4 is a greatly enlarged, fragmentary cross-sectional view of the area designated by the numeral 4 in FIG. 3.

FIG. 5 is a cross sectional view showing an alternate form of attachment of the release means to the sinker.

FIG. 6 is a cross-sectional view of an alternate form of sinker component of the assemblage of the invention.

FIG. 7 is a cross-sectional view of still another form of sinker component of the assemblage of the invention.

FIG. 8 is a generally illustrative view showing still another method of attaching the release means to the sinker and showing the assemblage engaging a bottom obstruction.

FIG. 9 is a generally illustrative view similar to FIG. 9 showing the effect of a line pull on the assemblage.

### DESCRIPTION OF THE INVENTION

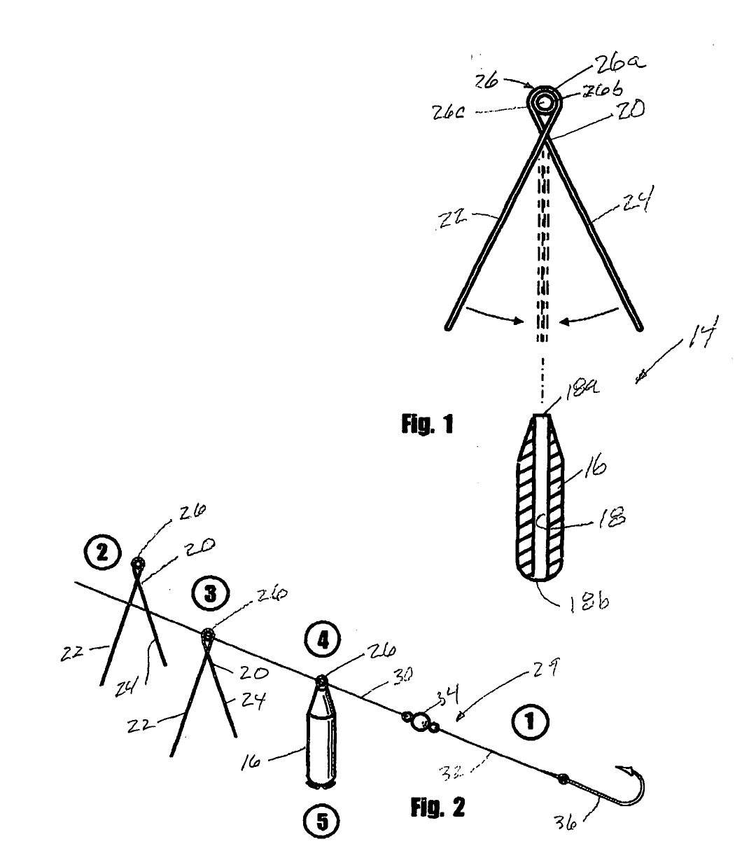

Referring to the drawings and particularly to FIG. 1, one form of the fishing line sinker assemblage of the present invention is there illustrated and generally identified by the numeral 14. In this form of the invention, assemblage 14 comprises a weighted body 16 having an axially extending central bore 18 having first and second ends 18a and 18b respectively. Telescopically received within central bore 18 of weighted body 16 is the important fishing line connector and release means of the invention for interconnecting the fishing line with the sinker or weighted body 16. This fishing line connector and release means here comprises a yieldably deformable member 20 which is preferably fabricated from a light gauge, malleable wire, such as, by way of example, a spring steel leader wire. Release member 20 is bent into the general configuration shown in FIG. 6 and uniquely includes first and second outwardly biased legs 22 and 24 that are joined proximate their upper ends in a uniquely formed connector coil 26. Connector coil 26, which is integrally formed with legs 22 and 24, comprises adjacently disposed coils 26a and 26b which define a line receiving passageway there between, the purpose of which will presently be described.

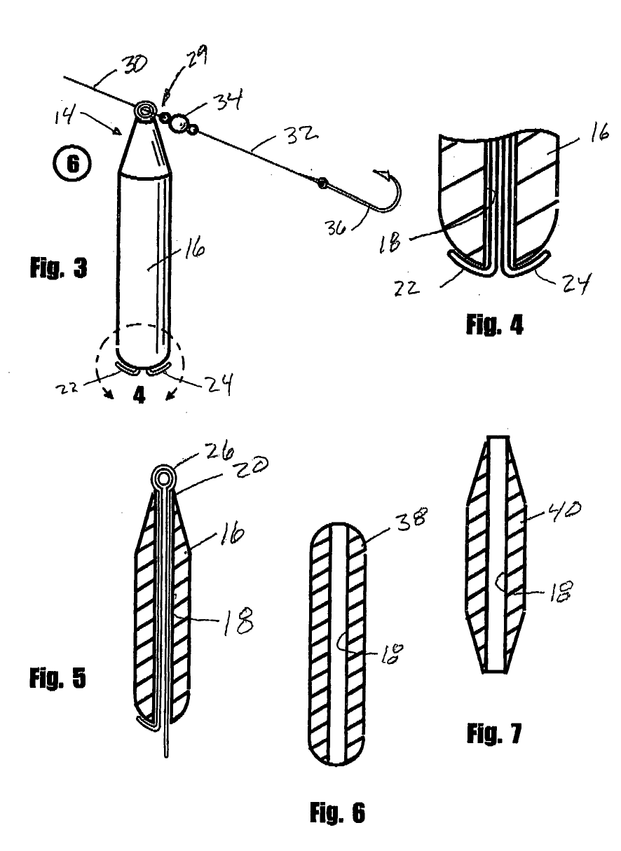

Referring to FIGS. 2 and 3, one form of the method of the present invention is there illustrated. In accordance with this method, the rigging 29 is first connected with yieldably deformable member 20 as indicated by step 2 in FIG. 2. As best seen in FIG. 2, rigging 30 circled (numeral 1 in FIG. 2) here comprises a first length of fishing line 30, a second length of fishing line 32, a conventional swivel 34 interconnected between the first and second length of fishing line and a conventional hook 36 which is connected to the outboard end of fishing line 32. Connection of the rigging 29 to member 20 is accomplished by feeding the line portioned 30 around the spiral loop 26 in a clockwise direction, much like installing keys on a key ring, to cause the line 30 to extend through the line receiving opening 26c. As the line 30 is fed around the spiral loop, the line will pass through the line passageway formed between the coils of the spiral loop so that it will be disposed within and extend through the line receiving opening 26c. With this novel arrangement, the fishing line need not be cut, nor the fishing rig disassembled to interconnect the fishing line with the release member 20.

With the fishing line extending through the loop 26 in the manner illustrated by the circled numeral 3 in FIG. 2, the sinker 16 can then be attached to the connector wire by compressing the wire legs of the connector wire together in the manner indicated by the dotted lines in FIG. 1 and then sliding the wire legs through the central bore 18 of the sinker. This done, one or both of the legs can be bent outwardly into close proximity with the outer surface of the sinker 16 and then cut in the manner illustrated in FIG. 4.

With the sinker 16 attached to the fishing rig 29 in the manner shown in FIG. 3, should the sinker become snagged, an upward pull on the line of between four and six pounds will cause the sinker to release from the release means, or spring wire member 20.

Referring to FIG. 5, an alternate method of attachment of the sinker to the release member 20 is there illustrated. In this form of the method of the invention, only one of the legs is bent outwardly and cut while the remaining leg is allowed to extend directly downward. With this arrangement, should the sinker become snagged, the sinker can be separated from the release member 20 by exerting a much lesser upward pressure on the fishing line than is required with the rigging shown in FIG. 3. This allows the use of a lighter line than the line made up of portions 30 and 32 (FIG. 3).

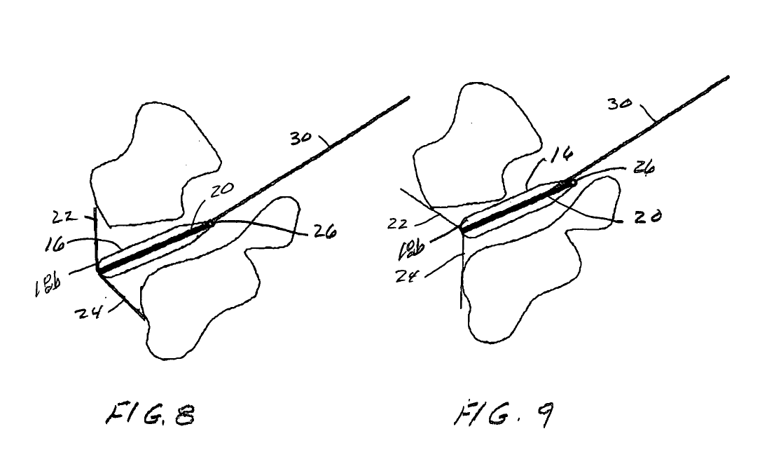

When desired, alternate forms of sinker design, such as those shown in FIG. 6 and 7 of the drawings and designated by the numerals 38 and 40 can be used with the rigging 29. These alternate sinker configurations can be interconnected with the rigging in the same manner as described in connection with the sinker configuration shown in FIGS. 1, 2 and 3.

Referring to FIGS. 8 and 9 and still another method of attachment of the sinker to the release member 20 is there illustrated. In this form of the invention, only both of the legs 22 and 24 are bent outwardly so that they extend angularly upward relative to the lower, rounded portion 8b of the sinker. In this instance, as shown in FIG. 8, the legs remain uncut and are naturally based upwardly and outwardly. With this arrangement an anchoring effect can be achieved which functions to hold the weight in position when bottom fishing in a swift current. This avoids having to use very heavy weights that will easily snag due to their size and bulk.

Due to the nature of the release means as previously described, the spring steel legs, upon catching the bottom as shown in the drawing will act as a spring to pull backwards on the line when drop fishing in a convention manner. After becoming snagging, if the weight is repositioned, the legs will automatically spring back to their starting position once again permitting the legs to provide the novel anchoring effect.

The unique bent wire configuration shown in FIGS. 8 and 9 also permits the weight to release from a severe snag at approximately eight pounds of resistance. This feature is particularly advantageous for a fisherman using heavy line as, for example 20 pound test or greater. Uniquely, the flexible steel, bent wire also prevent the weight from rolling on the bottom without snagging the sinker.

Having now described the invention in detail in accordance with the requirements of the patent statutes, those skilled in this art will have no difficulty in making changes and modifications in the individual parts or their relative assembly in order to meet specific requirements or conditions. Such changes and modifications may be made without departing from the scope and spirit of the invention, as set forth in the following claims.

We claim:

1. A method for removably attaching a sinker to a fishing line using an assemblage comprising a generally cylindrically shaped sinker having an outer surface and an axial through bore and a connector wire having first and second leg portions and a generally spiral shaped line connector portion connected to the leg portions, the connector portion comprising adjacently disposed coils defining a line receiving opening, the method comprising the steps of:
(a) feeding the line around the generally spiral shaped connector portion to cause the line to extend through the line-receiving opening;
(b) feeding the first and second leg portions of the connector wire through the axial through bore; and
(c) bending the first leg portion into proximity with the outer surface of the sinker to form a bent first leg portion.

2. The method as defined in claim 1 including the further step of cutting said bent first leg portion.

3. The method as defined in claim 1 including the step of bending the second leg portion into close proximity with the outer surface of the sinker to form a bent second leg portion.

4. The method as defined in claim 3 including the step of cutting said bent second leg portion.

5. A method for removably attaching a sinker to a fishing line using an assemblage comprising a generally cylindrically shaped sinker having an outer surface and an axial through bore and a connector wire having first and second leg portions and a generally spiral shaped line connector portion connected to the leg portions, the connector portion comprising adjacently disposed coils defining a line receiving opening, the method comprising the steps of:
(a) feeding the line around the generally spiral shaped connector portion to cause the line to extend through the line-receiving opening;
(b) feeding the first and second leg portions of the connector wire through the axial through bore; and
(c) bending the first and second leg portions outwardly and upwardly relative to the sinker to form bent first and second leg portions.

6. The method as defined in claim 5 including the further step of cutting one said bent first and second leg portions.

7. The method as defined in claim 5 including the further step of cutting both of said first and second leg portions.

8. A fishing line assemblage comprising:
(a) a generally cylindrically shaped sinker having an outer surface and an axial through bore; and
(b) a yieldably deformable connector wire having first and second leg portions and a generally spiral shaped line connector portion connected to said leg portions, said yieldably deformable connector wire connector portion comprising adjacently disposed coils defining a fishing line passageway there between and cooperating to define a line receiving opening.

9. The fishing line assemblage as defined in claim 8 in which said generally cylindrically shaped sinker includes a generally conically shaped end portion.

10. The fishing line assemblage as defined in claim 8 in which said generally cylindrically shaped sinker includes rounded end portions.

11. The fishing line assemblage as defined in claim 8 in which said generally cylindrically shaped sinker includes spaced apart, generally conically shaped end portions.

12. The fishing line assemblage as defined in claim 8 which said yieldably deformable connector wire comprises a malleable spring steel leader wire.

13. A fishing line assemblage comprising:
(a) a generally cylindrically shaped sinker, including a generally conically shaped end portion and having an outer surface and an axial through bore; and
(b) a yieldably deformable connector wire constructed from a malleable spring steel leader wire and having first and second leg portions and a generally spiral shaped line connector portion integrally formed with said leg portions, said yieldably deformable connector wire connector portion comprising adjacently disposed coils defining a fishing line passageway there between and cooperating to define a line receiving opening.

14. The fishing line assemblage as defined in claim 13 in which said generally cylindrically shaped sinker includes a rounded end portion.

15. The fishing line assemblage as defined in claim 13 in which said first and second leg portions of said yieldably deformable connector wire are normally biased outwardly.

16. A fishing line assemblage for use in bottom fishing comprising:
(a) generally cylindrically shaped sinker, including a generally conically shaped first end portion and a second end portion, said sinker having an outer surface and an axial through bore; and
(b) a yieldably deformable connector wire constructed from a malleable spring steel leader wire, said connector wire having;
(i) first and second leg portions extending through the axial bore in said sinker and having portions thereof bent outwardly and upwardly relative to said second end portion of said sinker for releasably snagging the bottom during bottom fishing; and
(ii) a generally spiral shaped line connector portion integrally formed with said leg portions, said yieldably deformable connector wire connector portion comprising adjacently disposed coils defining a fishing line passageway there between and cooperating to define a line receiving opening.
